(19) United States
(12) Patent Application Publication
(10) Pub. No.: US 2017/0037716 A1
(43) Pub. Date: Feb. 9, 2017

(54) A METHOD FOR THE RECOVERY AND EXPLORATION OF HYDROCARBONS FROM A SUBTERRANEOUS RESERVOIR BY MEANS OF GASES, A SYSTEM AND AN APPARATUS FOR THE EXECUTION OF THE METHOD

(71) Applicant: GALEXUM TECHNOLOGIES AG, Cham (CH)

(72) Inventors: Karel KOHLIK, Mellingen (CH); Karel KOHLIK, Campione d'ltalie (IT)

(21) Appl. No.: 15/303,034

(22) PCT Filed: Apr. 8, 2015
(86) PCT No.: PCT/IB2015/000451

§ 371 Date: Oct. 10, 2016

(30) Foreign Application Priority Data
Apr. 9, 2014 (CZ) PV 2014-243

(51) Int. Cl. E21B 43/24; C09K 8/592

(52) U.S. Cl. CPC E21B 43/24; E21B 43/2401; C09K 8/592; E21B 47/06

(57) ABSTRACT

A method for the secondary and/or enhanced recovery and exploration of hydrocarbons, especially crude oil, shale gas etc. from a subterraneous reservoir by means of gases produced by exothermic chemical reactions implemented in such a way that the above mentioned gases are produced from supplied chemical reagents, optionally further compounds, optionally air or oxygen and/or water in a chemical reactor, whereas the gases generated this way are introduced into to the productive formation (pay zone) in a controlled way, without the use of any additional supportive technical equipment, and by the effect of the elevated temperature and pressure in the productive formation (pay zone) the viscosity of the crude oil in the formation decreases, the pressure in the formation increases and potentially desired fractures in the formation occur, leading to the enabling of heavy crude oil recovery, to an enhanced heavy-, medium and light crude oil recovery or to the enabling of or enhancement of natural gas production. The invention further provides for a system for the recovery and exploration of hydrocarbons by applying the above mentioned method and for the apparatus design that is suggested in this system for the recovery and exploration of hydrocarbons in accordance with the above mentioned method.

### TECHNICAL FIELD

The invention relates to a method for the recovery and exploration of hydrocarbons, especially crude oil and/or shale gas etc. from an oil or gas well by means of gas production based on chemical reactions effectuated in a chemical reactor, which is preferably a dedicated chemical gas generator as set out in this patent application.

### PRIOR ART

The prior art relating to a secondary and enhanced recovery and exploration of hydrocarbons from oil and/or gas wells, which is mainly focusing on crude oil, relates primarily to the following methods:
a) Injection of standard gases from surface into the well by using compressed gas in pressure tanks and/or by injecting these gases through a regular gas compressor and potentially by a subsequent reinjection of the recovered gases into the well after prior separation of the gases from the recovered crude oil on surface.

The main disadvantage of this method is the need to supply gas in a convenient transportation compartment to the oil field (high volumes, high costs) and the fact that the injection of compressed gas out of gas tanks usually leads to a cold or only merely warm injection. If gas pipelines are used for permanent gas injection, such as e.g. CO₂-flooding, there are substantial mid-stream costs (pipeline and transport and maintenance) and in addition, gas that is heated during compression cools down again when reaching the bottom of the injection well. This method is preferably being used for shallower wells up to 600 m in cases of short stimulations or for a permanent gas flooding of the field at even higher depths. The most frequently used gases for this gas injection method are gaseous carbon dioxide CO₂ and nitrogen N₂.
b) Burning of fuel and/or other organic substances (catalysts) and/or gases on the surface and injection of the combustion products into the wellbore

An advantage of this method is the production of a considerable amount of energy in the form of heat, which targets mainly the viscosity of the crude oil. The disadvantages are similar to point a) here before, i.e. that the combustion products are cooling down on the way to the bottom of the injection well loosing a lot of its initial energy in the form of heat. Another disadvantage is the relative high price of the source products that are being burned and thus the commercial limitation, demanding a rather high oil price in order to be economically viable. The deeper the reservoir, the higher are the limitations as to a commercial viability.
c) Burning of fuel and/or other organic substances (catalysts) and/or gases downhole nearby the production zone (nearby the perforations if well is cased)

An advantage of this method is the production of a high quantity of heat and combustion products with a very limited loss of energy in the form of heat due to the proximity to the perforations and/or production zone. The main disadvantage is the rather high price of the source components (fuel/gas/oxygen and catalysts) and especially the problem that the downhole combustion chamber is difficult or even impossible to cool efficiently. As of today there is to the knowledge of the inventors and apart from the downhole gas generator as described in this patent application, no existing commercialized controllable downhole gas generating system being used on any oil- or gas field.
d) Exothermic chemical reaction based on multiple chemical compound injection through the production tubing or through concentric tubing

An advantage of this process is the production of warm or hot gases downhole and shortly before it enters the formation. Therefore there is hardly any negative cooling effect taking place in the tubing. The major disadvantage is the lack of control as to the injection of the components that re being mixed and especially the uncontrollable chemical reaction in the formation. There are severe temperature and pressure fluctuations downhole in the wellbore and potentially also in the formation itself, which basically makes it impossible to use this approach for heavy oil formations, furthermore, for any application there is a certain safety danger implied. Another advantage is the potential additional oxidization of the crude oil in the formation that produces NOx or oxygen.
e) Fire-flooding in crude oil reservoirs by supplying air or oxygen to the burning crude oil front (combustion front)

An advantage of this method is that there are not heat losses during the fire-flooding process and that there is a substantial production of heat. This method is also financially interesting as it does not generate a lot of costs for any source components. A major disadvantage is the lack of control as to the temperature development and the expansion of the combustion front in the reservoir.

With regard to the above mentioned disadvantages of the here presented methods as set out under the title of the prior art here before: lack of safety (chemicals with uncontrolled thermal-chemical decomposition, methods posing a risk to the persons applying the technology); energy consumption (there are substantial heat losses of the gases that are being pumped downhole, and hardly any reliable control of the chemical reaction, thus a low efficiency rate); the environment (some products from the mixtures of chemical compounds or waste substances are dangerous to the environment, or the formation might get damaged due to the uncontrolled stimulation which might furthermore also cause pollution, e.g. to the groundwater etc.); or economy (high costs of chemical compounds in relation to their subsequent combustion and recovery ratio), the here presented invention provides for a solution that eliminates to a major part the above mentioned disadvantages.

### SUMMARY OF THE INVENTION

The here described invention provides a solution of the above shown disadvantages by suggesting a method of secondary or enhanced recovery and exploration of hydrocarbons, especially crude oil, shale gas etc. from an oil well or gas well by means of gases produced on surface or downhole by controlled exothermic chemical reactions which are initiated and conducted by supplying specific chemical reagents, and/or air or oxygen, and/or water and optionally further compounds, into a dedicated chemical reactor, whereas the produced gases (incl. steam) are introduced into the productive formation (pay zone) in a controlled way (as to volume, pressure and temperature), and whereas the subsequent elevated formation temperature and formation pressure leads to a recovery of the before not flowing crude oil (secondary recovery: heavy crude oil) or the enhanced recovery of the crude oil, or the secondary or enhanced recovery of gas from tight gas formations.

Apart from the above mentioned method for the secondary and/or enhanced recovery of hydrocarbons, the invention also suggests an apparatus for the execution of this method in the form of a dedicated chemical gas generator (with a controlled exothermic chemical gas generating chamber), without additional supportive technical equipment.

For the purposes of this invention additional supportive technical equipment refers to other technical equipment suitable to increase the bottom hole pressure, e.g. a pumps, compressors etc. However, this does not refer to standard oilfield equipment that is still being applied, such as surface pumps for chemical and water supply, gas re-injection systems from oil-gas separation recovery, etc.

According to the inventors, there is no other method for secondary or enhanced recovery and production of hydrocarbons, as e.g. crude oil, shale gas or natural gas, that is based on generating gases (incl. steam) based on exothermic chemical reactions performed in a dedicated chemical reactor, that is preferably being designed as chemical gas generator according to this invention.

In this respect, specific and dedicated chemical compounds are mixed and being exothermically reacted in a dedicated chemical reactor, preferably in a chemical gas generator as suggested in this invention, whereas the controlled reaction of the initially aqueous solutions produce various gases and/or steam and energy in the form of heat. These hot gases (incl. steam) are mainly under its own produced pressure being pushed into the productive formation (pay zone).

The here suggested procedure and apparatus according to this invention provides for a high efficient recovery and production of all types of crude oil as well as natural gas.

According to the procedure and design as suggested in this invention, the here before mentioned chemical reactor is either positioned nearby the well on surface or, in an adapted design, positioned downhole in the wellbore. The gases (incl. steam) are then being produced in this chemical reactor, which is preferably designed as the here suggested chemical gas generator with a chemical gas generator chamber. Hot gases and steam having been produced in the dedicated chemical reactor will then be either led through a pipeline into the wellbore/tubing (surface chemical gas generator), or directly being generated and subsequently pushed into the formation nearby the wellbore entry (e.g. perforations) into the pay zone (downhole chemical gas generator).

In accordance with this invention, the method provides for a solution to efficiently recover and explore hydrocarbons by means of produced hot gases (incl. steam) based on a controlled exothermic chemical reaction and decomposition in the chemical reactor, preferably in a chemical gas generator, preferably with a dedicated chemical gas generator chamber, that maybe positioned nearby the wellbore on surface as shown in FIG. 1. This surface chemical gas generator design is preferably being used in shallow wells up to approx. 600 m. Thus, the hot gases (incl. steam) are being injected into the well on surface and pushed downhole the full length of the wellbore. The advantage of this surface chemical gas generator is a simpler construction that allows more space for the entire pressure, temperature and safety control units. The disadvantage in the application is the loss of heat that occurs between the outlet of the surface chemical gas generator and the openings into the productive formation (perforations if well is cased), which implies a rather long travel distance of the generated gases (incl. steam).

In accordance with this invention, the downhole chemical gas generator is being positioned directly in the wellbore as shown in FIG. 2, subject to the well being deeper than approx. 200 m. In this case, hot gases (incl. steam) are produced in the chemical reactor downhole and are being directly introduced into the reservoir by furthermore being sealed of to the top by a dedicated packer system that leads furthermore to a virtually lossless energetic gas/steam stimulation process, as the gases (incl. steam) and thus pressure are directly being produced downhole nearby the productive formation (pay zone). This efficient heating and pressurizing in the lower area of the wellbore leads to a decrease of the viscosity of the crude oil and furthermore increases the bottom hole pressure. The effect is an enhancement of the recovery rate or the enabling of a secondary recovery and exploration.

It is preferable if the chemical reactor is pre-heated with electric current in order to accelerate the exothermic chemical reaction of the mixed chemical compounds. However, some chemical mixtures do not require a pre-heating in order to efficiently initiate the exothermic reaction. Furthermore, the here suggested procedure and apparatus provides for a cooling ability in case of a sudden increase of the temperature inside the chemical reactor.

Another way of influencing and especially reducing the temperature of the generated gases during the reaction in the chemical reactor is the pumping of suitable chemical inhibitors to slow down or kill the reaction process. A skilled man in the art is well informed about such suitable inhibitors, that may be as an example water (H₂O) at regular outside temperature.

The advantage of the here suggested chemical reactor, which is preferably a chemical gas generator and that comprises ideally a dedicated chemical gas generator chamber, is that it is equipped with control elements that are preferably flow control valves and/or non-return valves, that can be controlled as to the flow volume of the individual chemical compounds (incl. chemical reagents), and optionally air or oxygen, and/or water, that are being injected into the chemical reactor, preferably in the design of the here suggested dedicated chemical gas generator with a chemical reaction chamber. This injection control mechanism enables to regulate the reaction and the composition process in the chemical reactor, preferably in the chemical reaction chamber, and thus control over temperature and pressure.

The temperature of the generated gases (incl. steam) in accordance with this invention preferably varies in the range of approx. 200° C. and approx. 300° C.

Compared to the bottom hole pressure in the near wellbore area of the productive formation (pay zone), the differential pressure to the pressure at the outlet of the gas generator amounts to approx. 3 MPa.

According to this invention, a further control system being applied for safety reasons and for monitoring and regulation reasons is the implementation of pressure and/or temperature measurement units in, preferably also below and, relating to the downhole chemical gas generator, preferably also above the chemical reactor (above the packer). These pressure and temperature sensors are continuously measuring the current values inside and in the proximity of the chemical reactor, whereas the respective data is being permanently monitored and evaluated on surface with a suitable monitoring and control system. Based on the incoming data from the respective sensors, the amount and the composition of the various chemical compounds (incl. chemical reagents), and/or water and/or air or oxygen, are being regulated manually or automatically in order to ensure an efficient gas generating process within a certain pre-defined temperature and pressure range.

For this method it is also possible to mix the in the chemical reactor generated gases with recovered gas from another well or from the same well by simultaneously injecting these gases into the well and by using a dedicated gas compressor in conjunction with the chemical gas generator. This recovered gas may be especially natural gas, N₂, N₂O, NO₂, O₂, CO₂ or H₂O (steam).

Apart from the detailed method of the gas generating process in the chemical reactor the following process is applied preferably:

Before applying the here described gas generating process, the wellbore and the near wellbore area shall be first treated with a regular cleaning process, such as xylene-injection, HCL-injection, or a combined surfactant-acid or solvent-acid treatment. This provides for a better distribution of the own generated gases (incl. steam) into the productive formation (pay zone).

After this pre-treatment, the productive formation (pay zone) is pre-heated and pressurized to an optimum temperature and pressure value by gases (incl. steam) produced in the chemical reactor.

Under certain circumstances, the following additional procedure is preferably being applied: A suitable oxidizer (air, oxygen and others) is, after pre-stimulation with the here suggested chemical reactor, being fed downhole through a dedicated injection line in order to be injected into the pre-heated productive formation (pay zone). The contact of the oxidizer with the heated crude oil will furthermore lead to an exothermic reaction (oxidizing process of the crude oil) if a certain temperature has been reached upfront. This secondary reaction process produces mainly hot CO₂ that is furthermore increasing the heat and widening the heating of the productive formation (pay zone), as well as increasing the formation pressure and thus leading to a further lowering of the viscosity of the crude oil in the formation and a higher recovery and exploration ratio due to the elevated formation pressure that pushes the crude oil towards the production well. By profiting also from the crude oil in the formation as a further energy source, the commercial viability of the here suggested procedure is thus being even elevated. However, the temperature in the formation shall never go beyond 270° C., as higher temperatures might cause a burning of the crude oil, which has to be prevented under any circumstances in order not start a fire flooding. This supplementary oxidizer-injection method is especially advantageous for extraction of heavy crude oil with a density of around 1 g/cm³ or lower (API-gravity 15 or lower).

The gas/steam generating process according the this invention and in relation to the chemical gas reactor shall be performed by an optimum mixture of suitable inorganic and/or organic chemical compounds, fed into the chemical reaction chamber individually or in a mixture, in an optimum solution based on the temperature of the injection liquid, and that lead, after being mixed, to an intense and efficient exothermic reaction with a high amount of heat and a maximum production of gas during their decomposition (reaction) process.

An especially suitable basic chemical compound for these reactions is ammonium nitrate (NH₄NO₃), either pure (pure aqueous solution NH₄NO₃ 60%-80%-H₂O 40%-20%) or in a mixture with further compounds that lead to more heat and more gases during the decomposition (reaction) process.

For a safer handling of these compounds (reagents) in accordance with this invention, these compounds should be used in an aqueous solution or an aqueous mixture. The efficiency of the reaction process can be increased by further adding suitable compounds to this basic mixture (e.g. NH₄NO₃, H₂O, suitable solvents and/or surfactants, suitable emulsifiers, acid such as HCL, phosphoric acid, etc.)

Thus a preferable reagent for the production of gases in accordance with this invention (basic chemical reagent) is an aqueous solution of ammonium nitrate (NH₄NO₃), or in a mixture with:
nitrite of an alkaline metal, which is Li, Na or K;
nitrate of an alkaline metal, which is Li, Na or K;
ammonium chloride or ammonium chloride and nitrite of an alkaline metal, which is Li, Na or K, or with ammonium chloride, nitrite of an alkaline metal, which is Li, Na or K and nitrate of an alkaline metal, which is Li, Na or K;
nitrate of an alkaline metal, which is Li, Na or K and hypochlorite of an alkaline metal, which is Li, Na or K.
Other chemical reagents are e.g. mixtures of an aqueous solution of sodium nitrate (NaNO₃) and/or sodium nitrite (NaNO₂) or their potassium salts.
In accordance with this invention, instead of sodium nitrite (NaNO₂), sodium hypochlorite (NaClO) or a metallic borohydride of the general formula MBH₄, where M is a metal, can be preferably used in the above mentioned mixtures as the reagents.
To increase the energy balance of the exothermic reactions a strong oxidizing reagent as e.g. sucrose C₁₂H₂₂O₁₁ is preferably added to the above mentioned chemical reagents, subject to the geology and properties of the rock in the productive formation.

### EXAMPLES OF CHEMICAL REACTIONS

The following examples provide an overview of possible applications of some reagents and their mixtures depending on the produced gases and formation of heat.

For the estimate of the temperature increase the specific heat of a 65.23% solution of ammonium nitrate (NH₄NO₃) is considered at 50° C., i.e. Cₚ=2.45 kJ/kg degree:
Decomposition of NH₄NO₃ during detonation (water in the products as steam):
   a) solid: NH₄NO₃=N₂+2H₂O+0.5O₂+1886 kJ/kg
   b) per 1 kg of the 65% NH₄NO₃ solution:

8.11(NH₄NO₃)+19.43(H₂O)₍ₗ₎=35.65H₂O_{(g)}+8.11N₂+4.05O₂+367 kJ/kjg
1070 dm³/kg of gaseous products; temperature increase approx. +150° C.
In case of insufficient initiation and/or inefficient thermal explosion NH₄NO₃ may decompose as follows (water in the products as steam):
   a) 4NH₄NO₃=3N₂+2NO₂ +8 H₂O+1832 kJ/kg
   b) 8NH₄NO₃=2NO₂+4NO+5N₂+16H₂O+513 kJ/kg
At relatively low temperatures and catalysis NH₄NO₃decomposes as follows (water in the products as steam):

NH₄NO₃=2H₂O+N₂O+584 kJ/kg
Mixture of NH₄NO₃ with ammonium chloride (water in the products as steam), based on the model 1a:

6.87NH₄NO₃+1.87NH₄Cl+19.43H₂O₍ₗ₎=0.93Cl₂+36.91H₂O_{(g)}+1.38O₂+7.80N₂
released heat 511 kJ/kg; 1050 dm³/kg of gaseous products; temperature increase approx. +208° C.
Mixture of NH₄NO₃ with ammonium chloride, initiated by 50% sodium nitrite (water in the products as steam), modeled on the basis of the decomposition 2a:

(6.87NH₄NO₃+1.87NH₄Cl+19.43H₂O₍ₗ₎)+(1.87NaNO₂+7.16H₂O₍ₗ₎)=1.87NaCl+7.02N₂+3.45NO₂+44.07H₂O_{(g)}
released heat 225 kJ/kg per mixture of both the solutions; 970 dm³/kg of gaseous products; temperature increase only approx. +90 to +100° C.; water introduced with sodium nitrite (50% aqueous solution H₂O) considerably lowers the temperature increase (ratio of the AN solution to the nitrite solution 4:1)
Mixture of NH₄NO₃ with ammonium chloride, initiated by 50% sodium nitrite (water in the products as steam), modeled on the basis of the decomposition 4:

(6.87NH₄NO₃+1.87NH₄Cl+19.43H₂O₍ₗ₎)+(1.87NaNO₂+7.16H₂O₍ₗ₎)=1.87NaCl+8.74N₂+3.45O₂+44.07H₂O_{(g)}
released heat 240 kJ/kg per mixture of both solutions; 970 dm³/kg of gaseous products; temperature increase only approx. +100 ° C.; water introduced with sodium nitrite nitrite (50% aqueous solution H₂O) considerably lowers the temperature increase (ratio of the AN solution to the nitrite solution 4:1)
Mixture of NH₄NO₃ with sucrose (62% NH₄NO₃, 6% sucrose, 32% water), (water in the products as steam):

7.74NH₄NO₃+0.17C₁₂H₂₂O₁₁+17.76H₂O₍ₗ₎=2.04CO₂+3.87N₂+33.41H₂O_{(g)}+2.68O₂
released heat 850 kJ/kg; 940 dm³/kg of gaseous products; temperature increase approx. +340° C.
Mixture of NH₄NO₃with sucrose and ammonium chloride (50% NH₄NO₃, 10% NH₄Cl, 6% sugar, 34% water), initiated by 50% solution of sodium nitrite (water in the products as steam):

(6.24NH₄NO₃+0.17C₁₂H₂₂O₁₁+18.87H₂O₍ₗ₎+1.87NH₄Cl)+(1.87NaNO₂+7.16H₂O₍ₗ₎)=2.04CO₂+1.87NaCl+44.12H₂O+7.17N₂+1.08O₂
released heat 885 kJ/kg per mixture of both the solutions; 1030 dm³/kg of gaseous products; temperature increase approx. +360° C.; water introduced with sodium nitrite (50% aqueous solution H₂O) considerably lowers the temperature increase (ratio of the NH₄NO₃ solution to the nitrite solution 4:1)
Mixture of NH₄NO₃with sucrose (62% NH₄NO₃, 6% sugar, 32% water), initiated by 50% solution of sodium nitrite (water in the products as steam):

(7.74NH₄NO₃+0.17C₁₂H₂₂O₁₁+17.76H₂O₍ₗ₎+(3.74NaNO₂+14.32H₂O_{(I)})=3.74NaNO₃+2.04CO₂+7.74N₂+49.43H₂O_{(g)}+3.87O₂
released heat 685 kJ/kg per mixture of both the solutions (2 parts of the AN solution to 1 part of the nitrite solution); 935 dm³/kg of gaseous products; temperature increase approx. +280° C.

For the generating of gases according to this invention, more reagents can be used, especially organic reagents as for instance presented in the published international application WO 2010/043239 A1, which is incorporated here by reference.

Another object of this invention is an apparatus for extraction and production of hydrocarbons from a subterraneous reservoir for the execution of the above mentioned method by means of a chemical reactor, preferably a chemical gas generator with a dedicated chemical gas generator chamber.

a) A Hydrocarbon Recovery and Exploration System Based on a Dedicated Chemical Gas Generator Positioned on Surface Nearby the Oil or Gas Well

The method of the here suggested procedure and the respective apparatus for the recovery and production of hydrocarbons, especially crude oil, shale gas etc. from a well by means of gases (incl. steam) generated by an exothermic chemical reaction on surface nearby the wellbore, comprises mainly the following elements:
i) an apparatus for the recovery and production of hydrocarbons comprising a chemical gas generator with a dedicated chemical reaction chamber for the purpose of generating hot gases from separately leaded-in chemical reagents, and/or optionally further compounds, and/or optionally water and/or optionally air or oxygen, whereas this apparatus for the recovery and production of hydrocarbons is positioned on surface and in the immediate vicinity of the oil or gas well;
ii) at least one gas/steam-pipeline, preferably heat-insulated, connected between the outlet valve of the surface chemical gas generator and the injection tubing in the wellbore in order to transport the generated hot gases/steam from the chemical gas generator directly into the wellbore;
iii) at least one production tubing, preferably heat-insulated, for the production of the recovered hydrocarbons (crude oil and/or gas) leading from the bottom of the wellbore to the wellhead, whereas one pipe (flow-line) is connected between the production tubing and the oil-gas-water separator unit and furthermore one pipe (flow-line) is connected to the oil tank / gas pipeline and one suitable oil pump (PC-pump, pump jack, etc.) to pump the recovered hydrocarbons to the surface, in case no artificial gas lift is being applied by a separate compressor or by the here disclosed chemical gas generating method;
iv) at least one feed pipe/tubing, preferably heat-insulated, connecting the chemical gas generator with a water tank, at least one feed pipe/tubing, preferably heat-insulated, connecting the chemical gas generator with the tank with the chemical reagent no. 1 (basic chemical compound, potentially pre-mixed with a suitable acid or alkaline compound), at least one feed pipe/tubing, preferably heat-insulated, connecting the chemical gas generator with the tank with the chemical reagent no. 2 (chemical initiator solution), ideally another feed pipe/tubing, preferably heat-insulated, connecting the chemical gas generator with the tank with a suitable acid or alkaline compound (if not pre-mixed with chemical reagent no. 1), ideally another feed pipe/tubing, connecting a separate air compressor with the chemical gas generator or directly with the injection tubing of the oil or gas well in order to potentially establish the here before mentioned oxidization process by injecting air/oxygen etc., all feed pipes/tubing, except for the air/oxygen etc. pipe/tubing, are furthermore connected to suitable liquid pumps and secured by control valves in order to regulate the desired injection volume of the various chemical compounds and water into the chemical gas generator;
v) a control and connected monitoring system, consisting of temperature and pressure sensors positioned directly in the chemical gas generating chamber and also positioned downhole in the wellbore, potentially above and below a suitable packer, or, if no packer is being applied, nearby the perforations (if well is cased) or the payzone (if well is open hole completion with liners/hangers or other completion), and furthermore consisting of regulation valves and flow meters and preferably also consisting of controllable liquid pumps that can be regulated, whereas the gathered data is being used to manually or electronically regulate the optimum chemical compound and/or water injection into the chemical reaction chamber in order to control and regulate the desired gas/steam generating process and within a given temperature and pressure range;
vi) a monitoring system for gathering and logging all data being collected by the various sensors (temperature sensors, pressure sensors, flow meter, pumping ratio, ph-value-meter, etc.) and for sending specific commands (manually or automatically) to the control units (control valves, liquid pumps, compressors, etc.), preferably by applying a dedicated software that logs and evaluates the gathered data and sends appropriately generated commands to the control units in order to perform the gas/steam generating process according to pre-set values (temperature range, pressure range, volume of gas production, etc.).

b) A Hydrocarbon Recovery and Exploration System Based on a Dedicated Chemical Gas Generator Positioned Downhole in the Wellbore

The method of the here suggested procedure and the respective apparatus for the recovery and exploration of hydrocarbons, especially crude oil, shale gas etc. from a well by means of gases/steam generated by an exothermic chemical reaction downhole in the wellbore, comprises mainly the following elements:
i) an apparatus for the recovery and production of hydrocarbons comprising a downhole chemical gas generator, ideally comprising a chemical reaction chamber, for the purpose of generating hot gases from separately leaded-in chemical reagents, and/or optionally further compounds, and/or optionally water and/or optionally air or oxygen, whereas this apparatus for the recovery and production of hydrocarbons is positioned downhole in the wellbore and in the vicinity of the productive formation (nearby the perforations and below a dedicated packer if well is cased, or, nearby the payzone if well is open hole completion with liners/hangers or other completion method);
ii) at least one feed pipe/tubing, preferably heat-insulated, connecting a water tank with the downhole chemical gas generator, at least one feed pipe/tubing, preferably heat-insulated, connecting the tank with the chemical reagent no. 1 (basic chemical compounds, potentially pre-mixed with a suitable acid or alkaline compound) with the downhole chemical gas generator, at least one feed pipe/tubing, preferably heat-insulated, connecting the tank with the chemical reagent no. 2 (chemical initiator solution) with the downhole chemical gas generator, ideally another feed pipe/tubing, preferably heat-insulated, connecting the tank with a suitable acid or alkaline compound (if not pre-mixed with chemical reagent no. 1) with the downhole chemical gas generator, ideally another feed pipe/tubing, connecting a separate air compressor with the downhole chemical gas generator or directly with the injection tubing of the oil or gas well in order to potentially establish the here before mentioned oxidization process by injecting air/oxygen etc., all feed pipes/tubing, except for the air or oxygen pipe/tubing, are furthermore connected to suitable liquid pumps and secured by control valves in order to regulate the desired injection volume of the various chemical compounds and water into the downhole chemical gas generator;
iii) if a stimulation occurs by using simultaneously a production tubing in the well: at least one production tubing, preferably heat-insulated, for the production of the recovered hydrocarbons (crude oil and/or gas) leading from the bottom of the wellbore to the wellhead, whereas one pipe/tubing (flow-line) is connected between the production tubing and the oil-gas-water separator unit and furthermore one pipe/tubing (flow-line) is connected to the oil tank/gas pipeline and one suitable oil pump (PC-pump, pump jack, etc.) to pump the recovered hydrocarbons to the surface, in case no artificial gas lift is being applied by a separate compressor or by the here patented chemical gas generator, or:
if a stimulation occurs by only lowering the downhole gas generator into the wellbore without a production tubing in the well: at least one suitable cable, preferably a steel cable, that is carrying the weight of the separate feed pipes/tubing being connected between the feeding tanks and the downhole chemical gas generator as set out in ii) here before, and that is furthermore carrying the weight of the chemical downhole gas generator and furthermore, while lowering the chemical downhole gas generator into the wellbore, carrying the weight of a dedicated feed-through packer that is set in the wellbore above the downhole chemical gas generator, whereas the recovery and production of the hydrocarbons (crude oil/gas) does not take place until the chemical downhole gas generator and the dedicated feed-through packer are removed again from the well after the occurred stimulation process according to this invention and until the necessary production tubing is again installed into the well, together with a suitable pumping system (crude oil), such as a PC-pump, a pump jack, etc. (in case no artificial gas lift system is being applied);
iv) a control and connected monitoring system, consisting of temperature and pressure sensors positioned directly in the chemical reactor (chemical reaction chamber) of the downhole chemical gas generator and furthermore also positioned in the wellbore further below the chemical gas generator and potentially positioned furthermore also above a suitable packer that is set shortly above the downhole chemical gas generator, or, if no packer is being applied, nearby the perforations (if well is cased) or the openings into the productive formation (payzone) (if well is open hole completion with liners/hangers or other completion), and furthermore consisting of regulation valves being set downhole in the wellbore attached to the separate feed pipes/tubing as set out in ii) here before and furthermore consisting of flow meters attached to the separate feed pipes/tubing as set out in ii) and preferably also consisting of controllable surface liquid pumps that can be regulated, whereas the gathered data is being used to manually or electronically regulate the optimum volume of injected chemical compounds (incl. chemical reagents), and/or optionally water and/or optionally air or oxygen, into the chemical reactor, ideally into the chemical chamber of the downhole chemical gas generator, in order to control and regulate the desired gas/steam generating process and within a given temperature and pressure range;
v) a monitoring system for gathering and logging all data being collected by the various sensors (temperature sensors, pressure sensors, flow meter, pumping ratio, ph-value-meter, etc.) and for sending specific commands (manually or automatically) to the control units (control valves, liquid pumps, compressors, etc.), preferably by applying a dedicated software that logs and evaluates the gathered data and sends appropriately generated commands to the control units in order to perform the gas/steam generating process according to pre-set values (temperature range, pressure range, volume of gas production, etc.).

Another object of this invention is the apparatus for recovery and production of hydrocarbons that consists of a chemical gas generator containing a dedicated chemical gas generator chamber (chemical reaction chamber) with monitoring sensors. The above mentioned chemical gas generator is being placed either:
a) on surface and nearby the oil or gas well

or
b) downhole in the wellbore.

a) The apparatus for recovery and exploration of hydrocarbons being placed on surface and nearby the oil or gas well comprises a surface chemical reactor, preferably a surface chemical gas generator with a chemical gas generator chamber (chemical reaction chamber) that is installed on a foundation element and is connected to at least one, ideally up to four, pipes/tubing, preferably heat-insulated, for the supply of the different chemical reagents, and/or optionally further compounds, and/or optionally water and/or optionally air or oxygen and that is also connected to power supply cables in order to run the optional electric heating in the chemical reaction chamber and that is furthermore also connected to data-lines for the connection of temperature, pressure and/or flow sensors leading to the central control system (ideally a computer with a dedicated monitoring and regulation software).

In a preferable embodiment the chemical gas generator contains a generator head and a chemical gas generating chamber (chemical reaction chamber) and an outlet that is connected to at least one pipe/tubing (gas/steam pipeline) being connected to the injection tubing of the crude oil or gas well, typically through a dedicated inlet at the wellhead. The chemical gas generator and at least one outlet pipe/tubing (gas/steam pipeline) are preferably heat-insulated.

b) The apparatus for recovery and exploration of hydrocarbons being placed downhole in the wellbore (crude oil well or gas well) comprises a downhole chemical reactor, preferably a chemical gas generator with a chemical gas generator chamber (chemical reaction chamber) that is positioned in the wellbore below a dedicated packer (preferably a feed-through packer with several feed-through bores) that is also set in the wellbore, whereas this downhole chemical gas generator is connected to at least one, ideally up to four, pipes/tubing, preferably heat-insulated and preferably flexible, for the supply of the different chemical reagents and/or optionally further compounds, and/or optionally water and/or optionally air or oxygen, and that is also preferably connected to power supply cables in order to run the optional electric heating in the chemical gas generating chamber and whereas the downhole chemical gas generator is furthermore also connected to data-lines for the connection of temperature, pressure and/or flow sensors leading to the central control system (ideally a computer with a dedicated monitoring and regulation software). Ideally, an adapted multi-feed-through packer is being used, that can be set hydraulically or electronically (and not mechanically). The feeding pipes/tubing and the data cable are preferably flexible and shall be first connected to the upper feed-through bores of the used packer and then being again connected to the lower outlet of the feed-through bores of the used packer and also connected to the respective inlet channels of the downhole chemical gas generator, whereas these channels lead separately into the downhole chemical gas generator (and thus into the chemical reaction chamber) where the different compounds are being mixed in order to start and maintain and regulate the gas (incl. steam) generating process. Above the packer, the feeding pipes/tubing are furthermore individually connected to regulated valves in order to control the individual flow of each chemical reagents and/or optionally further compounds, and/or optionally water and/or optionally air or oxygen, whereas the flow can also be stopped, if desired. Furthermore, all feeding pipes/tubing are furthermore connected to pressure valves in order to being able to generate higher pressures below the packer without getting backpressure in the individual chemical compound-, water- and/or air/oxygen-feeding pipes/tubing. All the downhole feeding pipes/tubing and the data cable(s) are sealed off at the packer in order to maintain the pressure and temperature resistance certification of the used packer. The lowering of the whole downhole system (downhole chemical gas generator, attached to the multi-feed-through packer, connected to the downhole feeding pipes/tubing and data cable(s)) into the wellbore, is substantially easier if the downhole feeding pipes/tubing and data cables(s) are flexible as to a certain bending angle, as it can then be rolled off standard cable drums from surface. The chemical gas generator with its chemical reaction chamber is being positioned in the wellbore directly below the packer and preferably attached to the packer or, if a production tubing is being used, preferably attached to the packer and/or the production tubing. Furthermore, a heat insulation shall be used in order to prevent the overheating and thus a malfunction of the packer and/or the valves and/or the downhole feeding pipes/tubing and/or the data cable(s).

At least one, ideally up to four, pipes/tubing, preferably heat-insulated, are being used for the supply of the different chemical reagents and/or optionally further compounds, and/or optionally water and/or optionally air or oxygen, and are separately fed through the packer through individual feed-through bores (e.g. NPT-bores), sealed off to a specifically rated temperature and pressure value, whereas these pipes/tubing are then also used in a special coating below the packer for heat and corrosion resistance, to lead the individual chemical reagents and/or optionally further compounds, and/or optionally water and/or optionally air or oxygen, into the chemical reactor, preferably into the chemical reaction chamber in the downhole gas generator, where these compounds are finally mixed and reacted in a controlled manner.

Depending on the approach, this downhole chemical gas generating system can be either applied on a pure stimulation basis without using a production tubing simultaneously, or, this system can provide for a solution with a dedicated packer that furthermore has a production bore in order to attach a production tubing, whereas the downhole gas generator is then also designed around this production tubing and in order to allow for the production of hydrocarbons (crude oil/gas) without the need to retrieve the downhole chemical gas generating system from the wellbore. Sealed off feed-through bores in the packer are also used in order to connect the temperature and pressure sensors below the packer and in the chemical gas generator and the electric heating in the chemical gas generator with the respective data and power cables.

The downhole feeding pipes/tubing and data cables(s) are preferably separate feeding pipes/tubing for the supply of the individual chemical compounds, water and/or air whereas the downhole feeding pipes/tubing may be either solid or flexible.

If solid downhole feeding pipes/tubing are used for the supply of the chemical reagents and/or optionally further compounds, and/or optionally water and/or optionally air or oxygen, a mechanical packer may be used instead of a hydraulic packer.

In a preferable embodiment the chemical reactor is a chemical gas generator.

The chemical gas generator positioned in the wellbore, or on surface nearby the oil or gas well comprises a chemical gas generator chamber, preferably a concentric one, fitted with at least one preferably concentric element for the dispersal of chemical reagents with at least one nozzle, wherein the chemical reagents and/or optionally further compounds, and/or optionally water and/or optionally air or oxygen are mixed and reacted in order to generate gases (incl. steam) in a controlled process. A generator head is connected to the chemical chemical reaction chamber that is fitted with at least one nozzle to which chemical reagents and/or optionally further compounds, and/or optionally water and/or optionally air or oxygen, are supplied via control valves.

The concentric element is preferably circular and it is preferentially made of stainless steel.

The bottom side of the gas generator has an opened outlet, either directly towards the bottom of the well in the case a downhole gas generator is being applied, or, connected to a pipe/tubing (gas/stem pipeline) that is attached to the injection tubing in the well, in the case a surface gas generator is being applied.

In another preferable embodiment at least one concentric element is equipped with an electric heating in order to pre-heat contact elements in the chemical reaction chamber to help initiating the desired exothermic chemical reactions.

Before the start of dispersing and/or injecting chemical reagents and/or optionally further compounds, and/or optionally water and/or optionally air or oxygen, a pre-heating of the concentric elements is preferably applied, whereas the chemical reagents and/or optionally further compounds, and/or optionally water, shall be dispersed directly on the heated element in order to enable a faster decomposition of the dispersed chemical reagents and/or optionally further compounds.

The exothermic decomposition reaction of the dispersed and mixed chemical reagents and/or optionally further compounds, additionally heats up the concentric elements in the chemical reaction chamber which provides for a higher efficiency of the decomposition process.

As the supply temperature of the chemical reagents is relatively constant (in the range of approx. 20° C. and 70° C., depending on the type and concentration of the basic reagent and initiation reagent), the quantity of the injection of the initiation reagent and/or optionally further compounds into the chemical reaction chamber must be controlled in such a way that the output temperature of the generated gases (incl. steam) and that the system pressure comply with the pre-set values. If the temperature and pressure control by varying and adapting the injection volume of the initiation reagent and/or optionally further compounds is not sufficient to maintain a specific temperature and/or pressure range, an inhibitor must be injected into the chemical gas generating chamber in order to slow down or kill the gas generating process and/or in order to cool down the system temperature and/or to lower the system pressure.

Gases (incl. steam) generated this way are automatically discharged from the gas generator due to the generated pressure and, if a downhole gas generator is being used, reach immediately through the opened outlet the bottom of the well below the gas generator and are thus entering and penetrating the hydrocarbon reservoir through the openings (perforations, liners, hangers, direct formation contract in open hole completion, outlet of strings in case of use of stimulation and/or production strings etc.).

If a surface chemical gas generator is being used, the generated gases/steam are routed from the outlet of the surface chemical gas generator to the well, through a gas/steam pipe/tubing (pipeline) and then downhole through the gas/steam injection tubing to the opening of the well into the productive formation (pay zone) whereas both surface pipe/tubing and injection tubing are preferably insulated.

The entire chemical gas generator shall also be heat-insulated for efficiency and safety reasons.

In the case of a surface chemical gas generator the shape of the generator and the element for dispersing and/or injecting chemical reagents and/or optionally further compounds, and/or optionally water and/or optionally air or oxygen, may be different from the circular shape as suggested in the design of the downhole chemical gas generator.

### BRIEF DESCRIPTION OF DRAWINGS

FIG. 1—shows a chemical reactor (chemical gas generator) installed on surface, connected to the wellhead and a scheme of the gas/steam flow to the productive reservoir and the recovery flow of the hydrocarbons

FIG. 2—shows a chemical reactor (chemical gas generator) installed downhole in the wellbore and a scheme of the gas/steam flow to the productive reservoir and the recovery flow of the hydrocarbons

### EXAMPLES

The present invention will now be disclosed in a more detailed way with reference to the attached drawings.

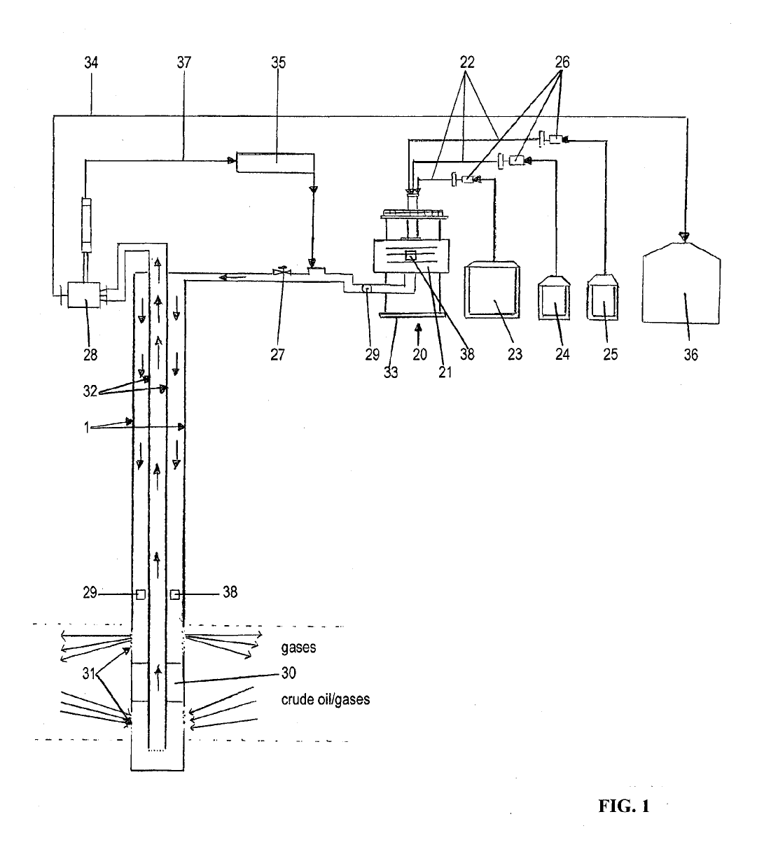

FIG. 1 shows a system and an apparatus for recovery and exploration of hydrocarbons from a subterraneous crude oil or natural gas reservoir that is designed as a chemical gas generator and that is positioned on surface nearby the (injection) well.

FIG. 1 shows a system for recovery and production of hydrocarbons, especially crude oil, shale gas etc. that consists of tanks 23, 24, 25, for chemical reagents and/or acid solution and/or water and/or further chemical compounds and optionally for the recovered and produced hydrocarbons 36 and other substances and each of the feeding tanks 23, 24, 25, is connected by means of feed pipes/tubing, preferably insulated, to the surface gas generator 20 containing a chemical reaction chamber 21 that is being fed by using separate pumps with downstream flow control valves 26 connected to the feed pipes/tubing 22 to supply chemical reagents and/or acid solution and/or water and/or further chemical compounds, into the chemical reaction chamber 21 and, potentially, a compressor to supply air or oxygen to the surface gas generator 20 order directly into the injection tubing in the wellbore. The system is further equipped with a control device to control the valves, the pumps and thus the mixture of the chemical reagents and inhibitors and potentially further chemical compounds, and insofar also to control the outlet temperature and pressure, and it is for this purpose also equipped with a monitoring device to monitor flow rates in the feed pipes/tubing, pressure and temperature in the chemical gas generator and also downhole in the wellbore, and potentially further parameters, such as e.g. PH-value in the chemical gas generator and also downhole in the wellbore.

FIG. 1 shows a system where the surface gas generator 20 containing the chemical reactor 21 is located on surface nearby the well. This surface gas generator is especially used in the case of shallow wells. In such a case, for the purpose of hydrocarbon recovery and exploration, the surface gas generator and the connected equipment as further described below, shall be positioned on surface in the immediate vicinity of the crude oil and/or gas well to ensure a certain efficiency.

The whole surface gas generating system includes the pumps with downstream flow control valves 26 for pumping chemical reagents and/or acid solution and/or water and/or further chemical compounds, from the tanks 23, 24 and 25, and potentially other chemical compounds from a further tank and, if appropriate, an air compressor (not shown in FIG. 1), through feeding pipes/tubing 22 into the chemical reactor 21. In the case of crude oil recovery the surface system also comprises a storage tank 36 for the recovered and explored hydrocarbons and furthermore, if necessary, a crude oil-gas-water separator or crude oil-water separator 28. Another part (not shown) may be a compressor in order to store the recovered gas from the well or to feed a dedicated gas pipeline or if the recovered gas is a by-product (in case of crude oil recovery and exploration), this gas may be fed through a gas pipeline 37 from the oil-gas-water separator 28 into a separate gas re-injection compressor 35 to re-inject the recovered gases from the well back into the injection tubing 1 or 32 (this can also be the regular production tubing, if no bridge plug as in FIG. 1 is being used). An integral part is a control system (not shown in FIG. 1) that controls the feeding of the chemical reactor 21 or the feeding of the well with air and/or oxygen (not shown in FIG. 1). This control system works based on the data gathered and evaluated from the various temperature sensors 29 and pressure sensors 38 (and potentially further sensors) that are positioned in the chemical gas generator 20 and that are also positioned downhole in the wellbore. If temperature and/or pressure reaches a crucial upper trigger point, the amount of the initiation reagent being introduced into the chemical reaction chamber is being lowered by sending the respective commands to the control valves and/or the regulated pumps 26, or the initiation reagent is not being introduced into the chemical reaction chamber anymore, only the basic reagent is being further introduced at a specific flow rate into the chemical reactor 21. To further accelerate this “cooling down” and “pressure lowering” process, a suitable inhibitor, such as e.g. water, can be further introduced into the chemical reactor 21 or directly into the wellbore, potentially through the injection tubing 1 or 32 (e.g. space between casing and production tubing or dedicated injection tubing or production tubing, depending on completion and/or packer setup). The gas (incl. steam) generating process can be also killed virtually immediately by not introducing any chemical reagent at all and/or by only introducing the inhibitor into the chemical reactor 21. If higher pressure rates and/or higher temperatures are desired, a higher amount of the basic reagent together with a higher amount of the initiation reagent is being introduced into the chemical reactor 21 by giving or sending the respective commands to the control valves in order to increase the flow rate and/or to the regulated pumps 26 in order to increase the pumping volume. Thus, the control system also includes flow rate measuring sensors for each individual compound being used (basic reagent, initiation reagent, water, acid-solution, etc.). A monitoring and logging device to monitor, log and evaluate all system data is included in the control system. All units needing power supply, e.g. pumps, control valves, sensors, computer with monitoring, logging and control software, etc., are connected to a power source.

The gas generator 20 for recovery and exploration of hydrocarbons (crude oil, natural gas, shale gas, etc.) is, if it is installed on surface nearby the well (FIG. 1), attached to a foundation element 33 and consists of a chemical reactor 21. The chemical reactor 21 is preferably a chemical gas generator reactor that consists of a generator head and a chemical gas (incl. steam) generator chamber (chemical reaction chamber). The generator head is connected to the chemical gas generator chamber. The generator head contains control and safety valves. The control valves are used to regulate the intake of the various chemical reagents and/or acid solution and/or water and/or further chemical compounds, and/or air or oxygen into the chemical gas generator chamber. Temperature sensors 29 and pressure sensors 38 are used to measure the temperature and pressure namely in the gas generator 20.

The outlet of the gas generator 20 is fitted with a gas/steam-pipeline, preferably heat-insulated, that leads directly into the injection tubing 1 or 32 of the wellbore (e.g. space between casing and production tubing or dedicated injection tubing or production tubing, depending on completion and/or packer setup). The chemical reaction chamber is constructed of individual elements made of stainless steel and/or other highly corrosion resistive materials. These elements may be both of a circular or rectangular shape and are attached to the chemical reaction chamber wall and are furthermore overlapping each other to force the introduced compounds to efficiently mix with each other and to force the introduced chemical reagents and/or acid solution and/or water and/or further chemical compounds, and/or air or oxygen to travel a longer pass-through way through the gas generator. Some of these elements are preferably heated to accelerate the gas generating process. The heating of these elements occurs preferably by electrical heating.

The here before described monitoring and control of the decomposition and/or exothermic reaction process of chemical reagents and/or acid solution and/or water and/or further chemical compounds, and/or air or oxygen, can be analogously applied to the decomposition and/or exothermic reaction process of chemical reagents and/or acid solution and/or water and/or further chemical compounds and/or air or oxygen in a downhole gas generator that is positioned in the wellbore.

In addition, it is preferable if the entire chemical gas generator 20 is heat insulated.

If the chemical generator is installed on surface, the generated gases (incl. steam) are led from the outlet of the surface chemical gas generator into the well preferably through heat insulated pipes/tubing.

Heat-insulated pipes/tubing shall also be preferably used in order to transport the generated hot gases (incl. steam) downhole in the wellbore and in order to have them energetically efficiently introduced through the openings (perforations if well is cased) into the productive formation (pay zone).

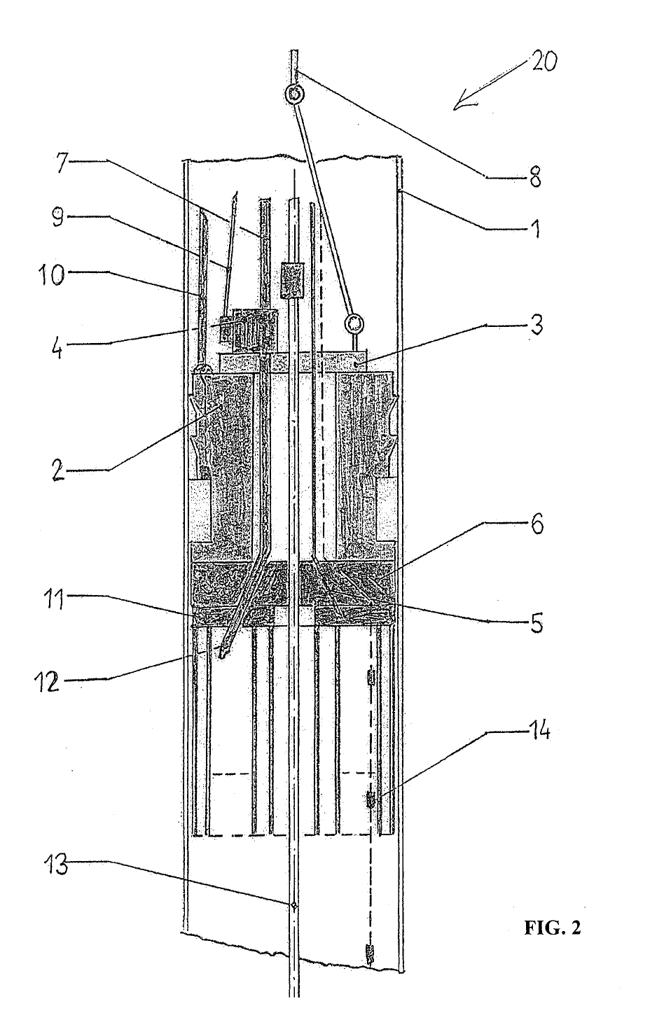

FIG. 2 shows a system and an apparatus for recovery and exploration of hydrocarbons from a subterraneous crude oil or natural gas reservoir that is designed as a chemical gas generator and that is positioned downhole in the wellbore nearby the productive formation (payzone).

The basic principle of this downhole chemical gas generating system remains in principle the same as the one of the surface chemical gas generator shown in FIG. 1.

However, the downhole chemical gas generator 20 that is placed downhole in the wellbore differs from the surface chemical gas generator with its particular structural design as follows.

The chemical generator 20 that is placed directly into the wellbore is set in FIG. 2 exemplarily in the casing 1 (if well is cased, other setting are also possible, depending on the completion of the well), in which a packer 2 with feed-through channels/bores is installed. On the packer 2 a sealing plate 3 is potentially installed (depending on the packer design) to which a group of valves is attached and that are sealed off, whereas these valves control the flow rate of the different chemical reagents (at minimum the basic reagent and the initiation reagent) and/or of water, and/or optionally of air/oxygen and optionally of further chemical compounds. The sealing plate 3 is also fitted with feed-through channels for the supply of chemical reagents, of water, air and/or further chemical compounds, as well as optionally with a production bore for the recovered and explored hydrocarbons (crude oil, natural gas, shale gas, etc.), which can be either concentric or eccentric, adapted to the setting of the production bore in the feed-through packer 2. A chemical reactor 11 is attached directly or in a small distance to the bottom part of the packer 2, the chemical reactor 11 being ideally separated from the packer 2 with heat insulation 6 and/or by having a small distance to the bottom of the packer 2. The heat insulation 6 and/or the attaching of the chemical reactor 11 in a certain distance to the bottom of the packer 2 prevent the packer 2 and its valves from overheating. Depending on how many individual feeding pipes/tubing and data cables are being used, the respective amount of feed-through bores shall preferably exist in the used feed-through-packer 2, whereas these feeding pipes/tubing and the data cable are each individually attached to or led through a sealed off feed-through bore in the packer (e.g. NPT's) in order to maintain a separated channel for each chemical reagent, water, and optionally air and optionally other chemical compounds, all the way down into the chemical reactor 11.

The chemical reactor 11 consists of a gas generator that comprises a generator head and a gas generator chamber (chemical reaction chamber). The generator head contains optionally a group of nozzles to efficiently supply chemical reagents, and/or water, and/or optionally other chemical compounds and/or air or oxygen into the chemical reaction chamber. This chemical reaction chamber contains at least one concentric element for the dispersal and efficient mixing of the various chemical reagents, and/or water, and/or optionally other chemical compounds, whereas it is connected to the generator head. It is preferable if several of these concentric elements are installed in the reaction chamber. The concentric elements may have a circular or rectangular design and shall be attached in a way that forces the mixed chemical reagents, and/or water, and/or optionally other chemical compounds to travel through the generator in a continuous “S”-way. The purpose is to ensure an efficient mixing of the various chemical reagents and optionally further chemical compounds in the reaction chamber and to ensure a prolongation of the passageway in the gas generator to leave enough reaction time so at the outlet of the gas generator mostly gases (incl. steam) are being released or at least combined with only a small part of a very homogenous mixture of all supplied chemical reagents and optionally other chemical compounds that ensure an efficient and integral gas (incl. steam) generation and reaction shortly after leaving the outlet of the downhole gas generator. At least one of the concentric elements in the reaction chamber is preferably electrically heated up. Temperature and pressure sensors are installed inside and preferably also below the chemical reaction chamber and preferably also below the outlet of the downhole gas generator.

The supply pipes/tubing 7 are used to supply chemical reagents and/or acid solution and/or water and/or further chemical compounds, and/or air or oxygen into the chemical reactor 11 from the respective tanks 23, 24, 25 and potentially further tanks with other compounds, which are the same as those of the system as disclosed in FIG. 1, whereas these chemical reagents and/or optionally acid solution and/or optionally water and/or optionally further chemical compounds, and/or optionally air or oxygen are supplied at the required temperatures and pressures ideally in separate supply pipes/tubing all the way downhole in the wellbore and through the feed-though packer, mixing finally and not until all the separately supplied chemical reagents and/or optionally acid solution and/or optionally water and/or optionally further chemical compounds, and/or optionally air or oxygen are reaching the chemical reaction chamber. Accordingly, gases (incl. steam) and heat are being fully generated in the wellbore and in virtually any desired depth up to approx. 5000 m or even more, thus eliminating energy losses that otherwise occur when supplying gases (incl. steam) and heat already from the surface. The generating of these gases (incl. steam) and heat lead to a pressurization of the targeted hydrocarbon formation and, potentially, if desired, to fractures in the targeted productive formation, and especially to a lowering of the viscosity of the crude oil, which leads to either the ability of a secondary recovery of heavy crude oil from a heavy crude oil reservoir and/or gas from a gas reservoir, or, to an enhancement of the recovery from any hydrocarbon reservoir (heavy crude oil, light crude oil, gas).

Hydrocarbons (crude oil, natural gas, shale gas) are being recovered and explored either through the regular production tubing that is leading through the dedicated production bore in the packer, while leaving the downhole chemical gas generator in the wellbore, or through a specially adapted production tubing that is being lowered into the wellbore together with the downhole gas generator for immediate recovery and exploration, or, in case of a pure stimulation application, after the stimulation process and retrieval of the downhole gas generator from the wellbore and subsequent re-setting of the production tubing/system into the wellbore. The recovered and produced hydrocarbons (crude oil, natural gas, shale gas) are then either led to a regular crude oil-gas-water separator 28 and/or to storage tanks and/or to pipelines.

The downhole system 20, i.e. downhole gas generator, packer, (flexible) pipes/tubing, valves, measuring components, is lowered into the wellbore using a suitable cable, ideally a steel cable 8 that is holding the overall weight, with the use of a special crane and/or work-over rig, into the wellbore, here the casing 1 of the well, and subsequently fixed by setting the packer 2 with the support of a hydraulic setting mechanism 10 and/or electric setting mechanism 9.

The packer 2, and, if applied, the sealing plate 3 and connected packer sealing, is/are equipped with a feed-through channel or several feed-through-channels where the individual pipes/tubing 7 for the separate supply of chemical reagents, water, air/oxygen and/or other compounds and/or data and power supply cables are attached and sealed off and led continuously and separately below the packer 2 into the downhole gas generator attached below the packer.

The supply pipes/tubing for chemical reagents, water and air/oxygen and other compounds consist of individual and separate supply pipes/tubing, which are either solid or preferably flexible. If the packer 2 is connected by using solid feeding pipes/tubing, then the packer can be set mechanically.

The control valves 4 are connected to the monitoring and control system on surface for the control of the flow rate of the chemical reagents, and/or water and/or air or oxygen and/or other chemical compounds. Temperature and pressure measuring sensors 14 are also connected to the surface monitoring and control system. Temperature and pressure sensors are installed both inside the chemical generator and also below the chemical generator. The measured temperature and pressure values are used to control the supplied quantities of the chemical reagents, and/or water and/or air or oxygen and/or other chemical compounds into the chemical generator, in order to control the temperature and pressure deployment in the wellbore below the packer 2 and consequently also in the productive formation (pay zone).

As the temperature in the chemical generator has to be monitored and controlled permanently, a temperature sensor is being installed in the generator, potentially also directly in the reaction chamber. It is preferable if another temperature sensor is installed below the chemical generator to measure the gas/steam and lower wellbore temperature after the occurred exothermic chemical reaction.

The gas generator shall preferably consist of a set of concentric pipes, preferably made of stainless steel or other materials with good heat conductivity, but with good resistance to chemical reagents and to corrosion etc. Some metal elements are optionally fitted with electric heating used to pre-heat the preferably concentric elements that are preferably set on top of the chemical generator, where the various chemical reagents and/or optionally acid solution and/or optionally water and/or optionally further chemical compounds, and/or optionally air or oxygen are being introduced and/or dispersed and mixed. As the chemical reactions are exothermic, these elements are later on heated up by these reactions in the reaction chamber and instead of being overheated the monitoring and regulation shall ensure that the exothermic reaction stays within certain pre-defined temperature ranges, potentially using water in order to cool down the chemical gas generator, preferably to the temperature of 200 to 250° C.

The optional electric pre-heating 5 of the concentric elements is connected to a power cable that leads all the way to surface.

Between the concentric elements in the generator head nozzles are installed that are used to disperse the chemical reagents and/or optionally acid solution and/or optionally water and/or optionally further chemical compounds, and/or optionally air or oxygen onto the (optionally pre-heated) concentric elements where they get mixed and react with each other.

The chemical reagents and/or optionally acid solution and/or optionally water and/or optionally further chemical compounds, and/or optionally air or oxygen are supplied to the downhole gas generator through individual and separate pipes/tubing 7 by using adequate pumps (liquid) or compressors (air or oxygen etc.) via the regulation of the control valves or overpressure valves 4 that are located over the packer 2, whereas these chemical reagents and/or optionally acid solution and/or optionally water and/or optionally further chemical compounds, and/or optionally air or oxygen are thus supplied through the packer 2 and the nozzles 12 into the chemical reactor 11 (ideally chemical reaction chamber).

These pipes/tubing 2 may be solid pipes (“injection lines”) or flexible pipes (“coiled tubing”).

Between the packer and the gas generator a heat insulation 6 is preferably applied. The heat insulation prevents overheating of the valves and of the packer, which shall be designed preferably as thermo-packer.

The packer is ideally positioned in the well at approx. 60 m above the top perforation (cased well) or entry into the formation (non-cased well).

It is important to note that if the payzone is rather thin, i.e. approx. up to 20 m, then just one packer is used as disclosed above, instead of using a bridge plug as shown in FIG. 1.

If the payzone is more than 20 m thick and if the casing has at least two perforation zones with a minimum distance of 10 m from each other and the recovery and production of hydrocarbons (crude oil, natural gas, shale gas etc.) and the stimulation process shall occur potentially simultaneously, a second “packer” (bridge plug) can be optionally used. In this case one packer with a connected downhole chemical generator and the entire gas generating system is located, as disclosed above, approx. 60 m above the top perforation (if well is cased) and a second packer (bridge plug) is located between the bottom and top perforation to ensure a pressure difference between the upper “injection”-zone and the lower “recovery”-zone. In such a case the bottom packer (bridge plug), preferably designed as a thermo-packer, is mechanically interconnected with the top packer using a concentric pipe through the top packer and down to the bottom packer (bridge plug). The bottom packer may be set mechanically, hydraulically or by using an electric setting system. The bottom packer (bridge plug) is preferably fitted on its top part with thermal insulation and water supply for cooling so that its temperature is not exceeding the maximum allowed temperature according to its temperature rating.

As during the decomposition of chemical reagents, depending on the used chemical reagents, corrosive compounds may be generated, appropriate corrosion inhibitors shall be preferably used, as for instance the “sacrificial anode” method. The sacrificial anode uses materials as zinc and/or other metals, that are attached to the chemical gas generator and/or into the space between the outside of the chemical gas generator and the casing.

Another appropriate method to prevent corrosion is using suitable corrosion inhibitors (e.g. phosphates) to be mixed and supplied together or separately with the chemical reagents.

### A Crude Oil Recovery Method Conducted in Accordance with the Invention

Crude oil recovery in accordance with this invention was conducted in a pay zone (hydrocarbon formation) at a depth of 1295-1340 feet.

The used apparatus comprised of a sealing (thermo packer)—gas generator assembly incorporated directly in the wellbore in accordance with FIG. 2.

The following data characterizes the process steps and results of the enhanced oil crude recovery in this particular well:
The Packer with the Gas Generator was Lowered to the Depth of: 1210 feet
Formation Pressure Before the Application: 150 psi
Formation Temperature Before the Application: 29° C.

Reagents (Chemicals):
A=65% NH₄NO₃ dissolved in water+7% NH₄Cl+1.2% H₃PO₄
B=37% NaNO₂+12% NaNO₃+51% H₂O (“tech-grade sodium nitrite”-solution)
Flexible Tubing 1: reagent A
Flexible Tubing 2: reagent B
Flexible Tubing 3: water
Flexible Tubing 4: air
Flexible Tubing 5: power supply, temperature, pressure, valve control
Flexible Tubing 6: hydraulic-setting for packer

Preparation for crude oil recovery in the technological sequence:
lowering the packer-generator-flexible tubing-valves system into the well using a steel cable;
connecting flexible tubing 6 to the hydraulic system;
setting the packer in the wellbore, approx. 100 m above the perforation;
fixing the steel cable and all flexible tubing at the well head;
attaching flexible tubing 1 to 3 via flow meters and control valves to the pumps;
connecting flexible tubing 4 via an overpressure and relief valve to the compressor;
connecting the line inside the flexible tubing 5 to the monitoring and control system;
connecting the chemical and water tanks;
connecting the pumps, compressor and control station to the electric mains.

The entire extraction process:
Cleaning the generator with air for 30 s
Heating the generator plates to 150° C.
Injection at the flow rate of reagent A=0.3 l/s and reagent B=0.3 l/s
Switching off the heating
   The temperature under the packer increased to 285° C. during 3 minutes.
Short water injection into the chemical reaction chamber:
Flow rate of reagent B reduced to 0.21 l/s,
   Temperature at 255° C.
Continuous control of reagent B (0.05-0.2 l/s):
   The temperature fluctuated between 240° C. and 260° C.;
   The pressure increased to approx. 285 psi during 30 minutes and remains almost constant
After 250 min process interruption due to a leak in flexible tubing 2 at the pump outlet. The temperature dropped to 225° C., the pressure decreased slightly
The generator was rinsed with approx. 20 l of water:
   The temperature dropped again.
The process was started again without heating of the generator plates:
   During 10 min the process got stabilized
After 31 hours the tank of reagent A (30 m³) was exhausted, the tank of reagent B up to approx. 60%:
   Short interruption and connection to another tank of reagent A. During operation connection to a new tank of reagent B
The process continued for another approx. 30 hours
Then, operation interruption, rinsing the reactor with water.

Amounts of chemicals that reacted in the generator: 60 m³ of reagent A and 46 m³ of reagent B
after 30 hours the pressure decreased to approx. 220 psi
opening the relief valve and connecting to the crude oil-gas-water separator
crude oil with water flowed for approx. 3 hours without pumping
after 5 hours—disconnecting the flexible tubing from the surface tanks
connecting the flexible tubing and steel cable to the hoisting crane
hydraulic disconnection of the packer
removing the flexible tubing and the packer-gas generator assembly from the well
connecting the crude oil pump to the well and connection to the crude oil-gas-water separator
crude oil extraction

Effect:

After application of the above mentioned method the production of crude oil was registered as an enhancement from an average of 954 l (6 barrels)/day to 6360 l (40 barrels)/day for 6 months.

A skilled men in the art will find it quite obvious that the herein disclosed method for secondary and/or enhanced recovery of hydrocarbons may contain other technical elements that are preferable, but for the invention they do not represent principal parts of the here defined systems, methods or apparatus. For the operation of the described systems, methods and apparatus they might be preferable, but not indispensable, which largely depends on the natural conditions or binding regulations valid in the particular region where this invention is being applied.

### FIG. 1

### LIST OF REFERENCE MARKS

20—apparatus for recovery and exploration of hydrocarbons
21—chemical reactor
22—supply pipes/tubing
23—chemical reagent tank (basic reagent)
24—chemical reagent tank (initiation reagent)
25—water tank or further compound tank
26—pumps with downstream flow control valves
27—control valve
28—crude oil-gas-water separator
29—temperature sensor
30—bridge plug (special packer)
31—perforations
32—production tubing
33—foundation element
34—crude oil flow line
35—optional gas re-injection system
36—oil tank
37—gas pipeline from separator to the optional gas re-injection system
38—pressure sensor

### FIG. 2

### LIST OF REFERENCE MARKS

1—casing
2—packer
3—sealing plate
4—valve
5—electric heating
6—heat insulation
7—supply of chemical reagents
8—suspension cable
9—electric control
10—packer hydraulic setting mechanism
11—chemical reactor
12—nozzle
13—production tubing
14—temperature and pressure sensors

1. A method for secondary and/or enhanced recovery and exploration of hydrocarbons, especially crude oil, shale gas etc. from a well by means of hot gases produced by exothermic chemical reactions, characterized in that the above mentioned gases are produced from chemical reagents and/or water, and/or optionally air/oxygen, that are introduced and mixed in a chemical reactor, wherein the gases are the product of exothermic reactions and whereas the produced gases are supplied to and introduced into the productive hydrocarbon formation (pay zone) in a controlled way, ideally without the use of any additional supportive technical equipment, and whereas by the effect of the elevated temperature and pressure these gases heat up and pressurize the productive hydrocarbon formation (pay zone) and optionally, if desired, lead to fractures in the productive formation (pay zone) and thus lead to a secondary and/or enhanced recovery and production of the hydrocarbons, namely crude oil, natural gas, shale gas, etc.

2. The method for secondary and/or enhanced recovery and exploration of hydrocarbons, in accordance with claim 1, characterized in that the above mentioned chemical reactor is
a) positioned on surface and nearby the crude oil well or gas well and the generated gases are supplied from the chemical reactor via at least one inlet into the wellbore and downhole to the openings (e.g. perforation) of the wellbore and introduced into the productive hydrocarbon formation (pay zone), or:
b) positioned downhole in the wellbore and the downhole generated gases are subsequently directly supplied to the to the openings (e.g. perforation) of the wellbore, and introduced into the productive hydrocarbon formation (pay zone).

3. The method for secondary and/or enhanced recovery and exploration of hydrocarbons, in accordance with claim 1 or 2, characterized in that the contact elements in the chemical reactor are pre-heated by means of electric current.

4. The method for secondary and/or enhanced recovery and exploration of hydrocarbons, in accordance with claims 1 to 3, characterized in that the chemical reactor in the well is cooled with water and/or air.

5. The method for secondary and/or enhanced recovery and exploration of hydrocarbons, in accordance with claims 1 to 4, characterized in that the volume of generated gases in the chemical reactor, their temperature and/or pressure are monitored and controlled using a control unit before they are introduced into the productive formation (pay zone).

6. The method for secondary and/or enhanced recovery and exploration of hydrocarbons, in accordance with claims 1 to 4, characterized in that the supplied quantities of chemical reagents, and/or optionally water, and/or air/oxygen are controlled at the inlet of the chemical reactor in order to control the resulting exothermic reaction and consequently the temperature and volume of the generated gases and thus the system pressure.

7. The method for secondary and/or enhanced recovery and exploration of hydrocarbons, in accordance with claims 1 to 6, characterized in that before the introduction of the generated gases into the wellbore these gases can be optionally mixed with recovered gas from the targeted well or from nearby wells, in advance separated from the recovered and produced crude oil and then introduced together with the generated gases into the wellbore in order to enhance the productivity.

8. The method for secondary and/or enhanced recovery and exploration of hydrocarbons, in accordance with claims 1 to 7, characterized in that the temperature of generated gases is ideally in the range of approx. 200° C. to approx. 300° C. and the differential pressure as compared to the formation (pay zone) pressure nearby the wellbore amounts to approx. 3 MPa, depending on the permeability of the productive formation (pay zone).

9. The method for secondary and/or enhanced recovery and exploration of hydrocarbons, in accordance with claims 1 to 8, characterized in that together with the generated gases and/or after the introduction of the generated gases into the productive formation (pay zone), air and/or oxygen is introduced into the productive formation (pay zone) through a separate inlet, in order to establish and/or maintain an oxidization of the heated hydrocarbons directly in the productive formation (pay zone), in order to enhance the productivity further by mainly generating CO₂.

10. The method for secondary and/or enhanced recovery and exploration of hydrocarbons, in accordance with claim 2, characterized in that the chemical reactor is located downhole in the wellbore below a packer and nearby the openings into the productive formation (pay zone), whereas these openings are usually the perforations—if wellbore is cased.

11. The method for secondary and/or enhanced recovery and exploration of hydrocarbons, in accordance with claim 10, characterized in that the chemical reactor is located downhole in the wellbore below a packer and approx. 50 to 100 m above the openings into the productive formation (pay zone), whereas these openings are usually the perforations—if wellbore is cased.

12. The method for secondary and/or enhanced recovery and exploration of hydrocarbons, in accordance with claims 1 to 11, characterized in that the chemical reactor is a chemical gas generator.

13. The method for secondary and/or enhanced recovery and exploration of hydrocarbons, in accordance with claim 1, characterized in that a chemical reagent, here the basic reagent, for the formation of gases is an aqueous solution of ammonium nitrate (NH₄NO₃), or in a mixture with:
nitrite of an alkaline metal, which is Li, Na or K;
nitrate of an alkaline metal, which is Li, Na or K;
ammonium chloride or ammonium chloride and nitrite of an alkaline metal, which is Li, Na or K, or with ammonium chloride, nitrite of an alkaline metal, which is Li, Na or K and nitrate of an alkaline metal, which is Li, Na or K;
nitrate of an alkaline metal, which is Li, Na or K and hypochlorite of an alkaline metal, which is Li, Na or K, or with sodium hypochlorite (NaClO) or borohydride of a metal, e.g. sodium borohydride, replacing the sodium nitrite in the mixture.

14. The method for secondary and/or enhanced recovery and exploration of hydrocarbons, in accordance with claim 1, characterized in that a chemical co-reagent for the formation of gases-initiation reagent is an aqueous solution of a mixture of sodium nitrate (NaNO₃) and/or sodium nitrite (NaNO₂), or a mixture of their potassium salts, or with sodium hypochlorite (NaClO) or borohydride of a metal, e.g. sodium borohydride, replacing sodium nitrite in the mixture.

15. The method for secondary and/or enhanced recovery and exploration of hydrocarbons, in accordance with claims 13 to 14, characterized in that a strong oxidation agent is added to the above mentioned chemical reagents, here to the basic reagent, and co-reagent as e.g. sucrose C₁₂H₂₂O₁₁.

16. A system for secondary and/or enhanced recovery and exploration of hydrocarbons, especially crude oil, shale gas etc. from a well by means of hot gases produced by exothermic chemical reactions in accordance with claims 1 to 15, characterized in that it comprises:
i) an apparatus for recovery and production of hydrocarbons containing a chemical reactor for the purpose of generating gases from mixed chemical reagents and/or water, and/or optionally air/oxygen, whereas this apparatus is positioned on surface nearby the crude oil well or gas well in which the generated gases shall be introduced;
ii) at least one pipe/tubing-gas-pipeline connected to the outlet of the chemical reactor and leading the generated gases from the chemical reactor downhole into the wellbore, ideally being connected to the injection tubing in the wellbore;
iii) at least one pipe/tubing for the production of the recovered and produced hydrocarbons-crude oil and/or gas, etc., being placed in the wellbore and reaching from the bottom of the wellbore to the surface, wherein at least one pipe/tubing is connected to the standard oil- and gas-field surface equipment such as production pumps and especially an oil-gas-water separator and an oil tank for storing the recovered and produced hydrocarbons;
iv) at least one, ideally up to four supply pipe(s)/tubing connecting the apparatus for hydrocarbon recovery and production with tanks for water, for chemical reagents, here the basic reagent, and chemical co-reagent, here the initiating reagent, and optionally for air/oxygen, whereas these tanks are located on surface nearby the targeted crude oil and/or gas well and nearby the apparatus for recovery and production of hydrocarbons, whereas another storage tank is being positioned on surface in order to store the recovered and produced hydrocarbons—crude oil, whereas the apparatus for recovery and production of hydrocarbons with the chemical reactor is connected to at least one tank for water, two tanks for chemical reagents—one tank for basic reagent and one tank for initiation reagent, potentially to another tank with further compounds, and potentially to a compressor for air/oxygen, whereas the respective supply pipe(s)/tubing are connected via control valves and/or pumps;
v) a control system connected to the valves and ideally to the pumps, regulating the apparatus for recovery and production of hydrocarbons by controlling the exothermic reactions on the basis of gathered data from temperature and pressure sensors and/or flow meters and relating to the properties and volume of generated gases, and:
vi) a monitoring system for gathering and logging all process- and reaction-data, connected to the control system.

17. A system for secondary and/or enhanced recovery and exploration of hydrocarbons, especially crude oil, shale gas etc. from a well by means of hot gases produced by exothermic chemical reactions in accordance with claims 1 to 15, characterized in that it comprises:
i) an apparatus for recovery and production of hydrocarbons containing a chemical reactor for the purpose of generating gases from mixed chemical reagents and/or water, and/or optionally air/oxygen, whereas this apparatus is positioned downhole in the wellbore, and whereas the system further comprises:
ii) at least one, ideally up to four supply pipe(s)/tubing connecting the downhole apparatus for hydrocarbon recovery and production with tanks for water, for chemical reagents, here the basic reagent, and chemical co-reagent reagent, here the initiating reagent, and optionally for air/oxygen, whereas these tanks are located on surface nearby the targeted crude oil and/or gas well and whereas another storage tank is being positioned on surface in order to store the recovered and produced hydrocarbons—crude oil, whereas the apparatus for recovery and production of hydrocarbons with the chemical reactor is connected to at least one tank for water, two tanks for chemical reagents—one tank for basic reagent and one tank for initiation reagent, potentially to another tank with further compounds, and potentially to a compressor for air/oxygen, whereas the respective supply pipe(s)/tubing are connected via control valves and/or pumps;
iii) at least one pipe/tubing for the production of the recovered and produced hydrocarbons—crude oil and/or gas, etc., being placed in the wellbore and reaching from the bottom of the wellbore to the surface, wherein at least one pipe/tubing is connected to the standard oil- and gas-field surface equipment such as production pumps and especially an oil-gas-water separator and an oil tank for storing the recovered and produced hydrocarbons;
iv) a control system connected to the downhole and/or surface valves and ideally to the pumps, regulating the apparatus for recovery and production of hydrocarbons by controlling the exothermic reactions on the basis of gathered data from temperature and pressure sensors downhole in the wellbore and/or on surface and/or flow meters and relating to the properties and volume of generated gases, and;
v) a monitoring system for gathering and logging all process- and reaction-data, connected to the control system.

18. The system for secondary and/or enhanced recovery and exploration of hydrocarbons, especially crude oil, shale gas etc. from a well by means of hot gases produced by exothermic chemical reactions in accordance with claim 16 or 17, characterized in that the chemical reactor is a chemical gas generator.

19. The system for secondary and/or enhanced recovery and exploration of hydrocarbons, especially crude oil, shale gas etc. from a well by means of hot gases produced by exothermic chemical reactions in accordance with claims 16 or 17 and 18, characterized in that the control system is connected to temperature sensors, pressure sensors and/or flow meters as to the chemical reagents and water, whereas the temperature and pressure sensors are installed in the chemical gas generator and nearby the openings into the productive formation (pay zone), whereas these openings are usually the perforations—if wellbore is cased.

20. The system for secondary and/or enhanced recovery and exploration of hydrocarbons, especially crude oil, shale gas etc. from a well by means of hot gases produced by exothermic chemical reactions in accordance with claim 16 or 17, characterized in that the chemical reactor and the inlet and outlet pipe/tubing are heat insulated.

21. An apparatus for secondary and/or enhanced recovery and exploration of hydrocarbons, especially crude oil, shale gas etc. from a subterraneous crude oil or gas reservoir by means of hot gases generated by exothermic chemical reactions, using the method in accordance with any of claims 1 to 15 and applying the system in accordance with claims 16, 18 to 20, characterized in that the surface apparatus for recovery and production of hydrocarbons consists of a chemical reactor that is installed on a foundation element (33) and is connected to at least one, ideally up to four pipe(s)/tubing for the supply of chemical reagents, and/or potentially further compounds, and/or potentially water and/or air or oxygen, the chemical reactor being fitted with electricity supply cables for electric heating and data cables for the connection to the temperature sensors, pressure sensors and/or flow meters, all connected to the control system.

22. The apparatus for secondary and/or enhanced recovery and exploration of hydrocarbons, especially crude oil, shale gas etc. from a subterraneous crude oil or gas reservoir by means of hot gases generated by exothermic chemical reactions, using the method in accordance with any of claims 1 to 15 and applying the system in accordance with claims 17 to 20, characterized in that the downhole apparatus for recovery and production of hydrocarbons comprises the casing (1) in the well, in which a packer (2) with one or several feed-through channel(s) is/are installed, whereas on top of or within the packer (2) a sealing plate (3) is implemented, to which a group of valves (4) for the control of individual flows of chemical reagents, optionally water and air or oxygen, is fixed and sealed; the sealing plate (3) is fitted with one or several feed-through channel(s), concentric with the feed-through channel(s) in the packer (2);
on the bottom part or shortly below the packer (2) a chemical reactor (5) with a chemical reaction chamber is positioned, and the chemical reactor (5) is ideally sealed from the packer (2) with heat insulation (6), preventing an overheating of the packer (2) and/or the valves (4); at least one, ideally up to four supply pipe(s)/tubing (7) run(s) inside the feed-through channel(s) of the packer (2) to ensure a separate supply of chemical reagents, and/or further compounds, and/or water and/or air or oxygen into the chemical reactor (6).

23. The apparatus for secondary and/or enhanced recovery and exploration of hydrocarbons, especially crude oil, shale gas etc. from a subterraneous crude oil or gas reservoir by means of hot gases generated by exothermic chemical reactions, in accordance with claim 22, characterized in that the sealing plate (3) or the top of the packer (2) is fitted with a suspension mechanism in order to attach a rigid cable, ideally a steel cable (8), for lowering and setting and removal of the downhole apparatus into an from the wellbore, especially if flexible pipes/tubing are used in the wellbore in order to supply chemical reagents, optionally water and/or air or oxygen.

24. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 22, characterized in that to the feed-through channels in the packer (2) and/or the sealing plate (3) and sealing of the packer (2) at least one, ideally up to four pipe(s)/tubing is/are attached for the separate supply of reagents, optionally water and/or air or oxygen, into the gas generator, as well as optionally at least one pipe/tubing is installed and led through the production bore of the packer (2) for the delivery of the recovered and produced hydrocarbons to the surface-through the production tubing, as well as power supply and data cables are installed and led through at least one feed-through bore (NPT-bore) for the optional electric heating and the connection to the temperature and pressure sensors, and sending the data from the sensors to the control and monitoring system on surface.

25. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 22, characterized in that the packer (2) is equipped with a hydraulic or electric setting mechanism, especially if flexible pipes/tubing are used in the wellbore in order to supply chemical reagents, optionally water and/or air or oxygen.

26. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claims 21 and 22, characterized in that the supply pipes/tubing are separate pipes/tubing for a separate supply of each of the chemical reagents, optionally water and/or air or oxygen.

27. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 26, characterized in that the supply pipes/tubing are either solid pipes/tubing or flexible pipes/tubing.

28. The apparatus for secondary and/or enhanced recovery and exploration hydrocarbons, especially crude oil, shale gas etc. from a subterraneous crude oil or gas reservoir by means of hot gases generated by exothermic chemical reactions in accordance with claims 22 and 27, characterized in that the packer (2) is equipped with a mechanical setting mechanism if solid pipes/tubing are used.

29. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 21 or 22, characterized in that the chemical reactor is a gas generator.

30. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 29, characterized in that the gas generator contains a chemical reaction chamber fitted with at least one element, preferably concentric, for a dispersal and mixing of the chemical reagents and/or optionally water, and a generator head fitted with at least one nozzle for chemical reagents and/or optionally water, whereas control valves for a controlled introduction of chemical reagents and/or optionally water into the generator are also connected to the supply pipe(s)/tubing.

31. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 30, characterized in that the concentric element in the chemical reaction chamber, preferably a circular one, is made of a metal plate, preferably stainless steel.

32. The apparatus for secondary and/or enhanced recovery and exploration of hydrocarbons, especially crude oil, shale gas etc. from a subterraneous crude oil or gas reservoir by means of hot gases generated by exothermic chemical reactions in accordance with claim 31, characterized in that at least one concentric element in the reaction chamber is ideally equipped with an electric pre-heating in order to support the initiation of the exothermic reactions.
